(19) United States
(12) Patent Application Publication
(10) Pub. No.: US 2002/0002226 A1
(43) Pub. Date: Jan. 3, 2002

(54) Preparation of super absorbent polymers

(76) Inventor: Geoffrey William Barnett, Moreton (GB)

Correspondence Address: Alexis Barron, Esquire, SYNNESTVEDT & LECHNER LLP, 2600 Aramark Tower, 1101 Market Street, Philadelphia, PA, 19107-2950, US

(21) Appl. No.: 09/789,382

(22) Filed: Feb. 21, 2001

(30) Foreign Application Priority Data
Feb. 21, 2000 (GB) 00-03964.4

(51) Int. Cl. B05D 3/02; C08K 3/00; C08L 51/00; C08K 5/05

(52) U.S. Cl. 524/386; 427/384; 524/504; 524/522

(57) ABSTRACT

A process for preparing coated water-absorbing compositions, especially for use in personal hygiene products, comprises coating a super-absorbent polymeric material with an aqueous coating medium which besides water comprises at least one (or more) polyhydric alcohol(s) having hydroxyl substituents on non-adjacent carbon atoms, the said medium being substantially free of organic solvents.

The present invention is concerned with water absorbing compositions and, in particular, those based on hydrogel-forming super absorbers which find use in the preparation of items for personal hygiene, such as diapers and incontinence padding, and also for horticultural and agricultural purposes.

### BACKGROUND OF THE INVENTION

Water-insoluble, hydrogel-forming polymers are well known for personal hygiene and for horticultural and agricultural use because of their ability to retain water and swell without dissolving therein. Such “super absorbers”, as they are commonly known, are usually employed as granules, the size of the granule depending on the intended use. They are often, but not necessarily, based on part-neutralised polyacrylate polymers. The polymers are made by methods such as those disclosed in EP 0,530,438 and EP 0,536,128.

Such super absorbers are expected to exhibit a range of desirable properties. For example, they should exhibit an adequate ability to continue to function when subject to pressure, for example, when a baby is sitting on a diaper, so as to exhibit high absorbency against pressure (“AAP”). Further, the total capacity of the polymer to retain water, as measured by the centrifuge retention capacity (“CRC”), must remain high.

Various techniques have been developed to improve the performance of super absorbers. One such technique involves the application to the surface of the polymer of an additional cross-linking coating. GB 2,162,525 describes such a process whereby a water absorbing resin powder is treated with a polyhydric alcohol. The resin is acidic, and the alcohol reacts therewith presumably by esterification to cross-link over the surface and thereby so-to-speak to “corset” the powder granules, so that their performance characteristics are thus improved. In the process of GB 2,162,525 the cross-linking reaction has to be carried out in the presence of a hydrophilic organic solvent, such as a lower alcohol, ketone or ether.

There are however disadvantages with this known process, in particular the separation problems associated with the solvent recovery, the fire dangers and the cost of the solvent itself. In addition, it has been found that the use of conventional polyhydric alcohols, such as propylene glycol (1,2-propanediol), causes the build-up of an unpleasant odour released from wetted articles employing such super absorbent polymers.

### STATEMENT OF THE INVENTION

Surprisingly we have now found that it is possible to attain coated super absorbent polymers with an excellent AAP combined with good CRC yet free of the build-up of unpleasant odours by employing selected polyhydric alcohols in the absence of hydrophilic organic solvent.

According to this invention, we provide a process for preparing a coated water-absorbing composition, which process comprises coating a super-absorbent polymeric material with a coating medium which besides water comprises one or more polyhydric alcohols having hydroxyl substituents on non-adjacent carbon atoms, the medium being substantially free of organic solvent.

It will be understood that the polyhydric alcohols with non-adjacent hydroxyls used in the process of this invention serve as cross-linking reactants, and as such are not here to be regarded as solvents.

Furthermore, the cross-linking reaction between the polyhydric alcohols with non-adjacent hydroxyls and the resin powder can and desirably should take place in the complete absence of any extraneous organic solvent. The use of industrial-grade chemicals with normally-acceptable levels of impurity is however not excluded, and obviously the process can be successfully operated to secure most of the advantages of this invention even in the presence of minimal amounts of hydrophilic organic solvent if anyone perversely chooses to incorporate it

Consequently, for the avoidance of doubt, be it noted that the term “substantially free of organic solvent” is used herein to mean that the medium includes no more than about 1 wt. % of organic solvent at most. And in preferred form, the medium should include organic solvent, if at all, in an amount no greater than about 0.1 wt. %. However, in its most preferred form, the medium does not contain any deliberately-added organic solvent whatsoever.

### DESCRIPTION OF PREFERRED EMBODIMENTS

Preferably the polyhydric alcohol with non-adjacent hydroxyls is 2-methyl-1,3-propanediol, although other polyhydric alcohols such as 1,4-butanediol, 1,3-propanediol and low molecular weight polyethylene glycols may be employed. Naturally 1,2-propanediol is not satisfactory, and is to be avoided in this invention.

Preferably the super absorbent polymeric material is a part-neutralised water-insoluble hydrogel-forming resin derived from cross-linked polyacrylic acid. However, other water absorbing resins may be used such as the hydrolyzate of a starch-acrylonitrile graft polymer, the neutralisation product of a starch-acrylic acid graft polymer, the saponification product of a vinyl acetate-acrylic ester copolymer, the hydrolysate of an acrylonitrile copolymer and the hydrolysate of an acrylamide copolymer. Such super absorbent polymeric materials may be prepared by bulk or precipitation polymerisation for example by the method described in EP 0,530,438.

For example, cross-linked polyacrylates may be prepared by mixing acrylic acid and/or a derivative thereof such as acrylamide, methacrylic acid or methyl methacrylate, either singly or in admixture, if appropriate also together with cross-linkers and other desired additives, such as water-soluble modified cellulose, and then polymerising the mixture . . . in bulk, in film form (for example up to about 5 cm depth) or dispersed as droplets in a non-polar solvent such as hexane.

A preferred polymer is a partially neutralised acrylate polymer lightly cross-linked with preferably less than 2% trimethylolpropane triacrylate. For example, a trimetholpropane triacrylate molar concentration of 0.02 to 4 M %, based on acrylic acid is suitable. However other suitable super absorbent polymers are well known in the art, employing alternative base monomers and cross-linking agents.

The polymeric material is generally supplied in powdered form.

The coating is preferably carried out at a temperature of from 140 to 250° C. and preferably for a time period of from 5 minutes to 2 hours, dependent on the temperature employed. Preferred conditions employ a temperature of 180° C. to 220° C. and a time of from 10 to 40 minutes.

The coating medium of polyhydric alcohol dissolved in water is used so as to give a concentration of alcohol with respect to polymer in the range of 0.2 to 3.2 wt. %. Preferably the concentration is from 0.4 to 1.6 wt. %.

The coating ratio, i.e. the weight of total coating solution as a percentage of the weight of the polymer can be from 0.1 to 100%, and is preferably from 1 to 10% and most preferably from 3 to 6%.

### EXAMPLES AND DRAWINGS

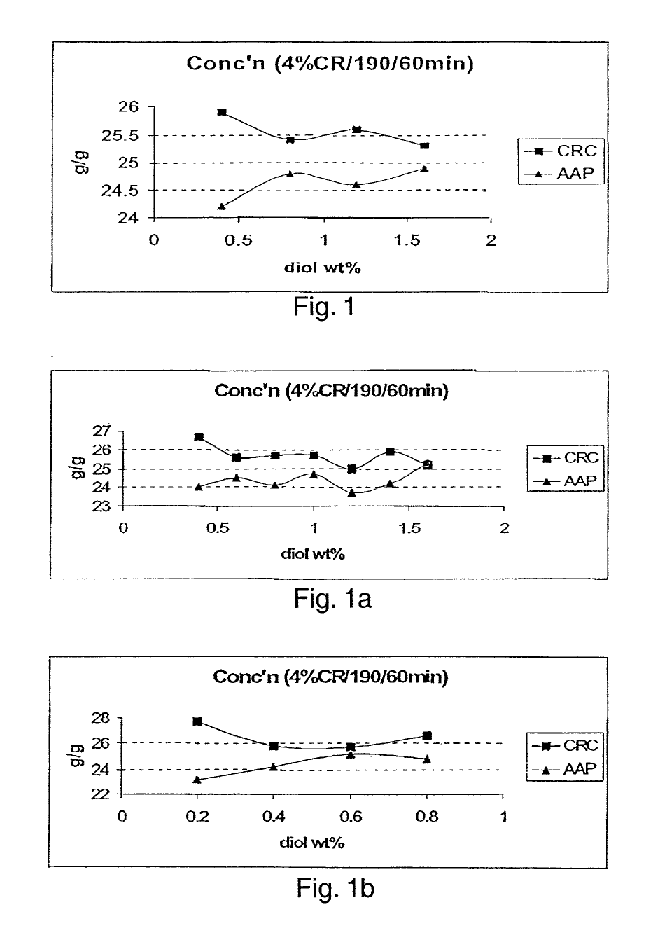

In order that the invention can be fully understood it will now be further described, though only for purposes of illustration, with reference to the following Examples and FIGS. 1 to 7 of the accompanying drawings.

The base polymer employed was a conventional partially neutralised sodium salt of a cross-linked polyacrylic acid.

CRC (centrifugal retention capacity) was determined by edana method 441.1-99 and AAP (absorption against pressure) was determined by edana method 442.1-99 modified so as to give a working pressure of 49 g/cm². These edana methods are standards of the European Disposables and Non-wovens Association.

### Example 1

Samples (15 to 20 g) of powdered base polymer were mixed with a coating solution of 2-methyl-1,3-propanediol dissolved in water and heated for 60 minutes at 190° C. In each case the weight of coating solution and weight of polymer were such as to give a coating ratio (CR) of 4%. However the concentration of diol with respect to polymer was varied in each case.

The results are shown in Table 1 below and graphically in FIG. 1 where the y axis gives the weight (g) of solution absorbed per gram of polymer for the two tests.

TABLE 1

| Diol wt % | CRC (g/g) | AAP (g/g) |
|---|---|---|
| 0.4 | 25.9 | 24.2 |
| 0.8 | 25.4 | 24.8 |
| 1.2 | 25.6 | 24.6 |
| 1.6 | 25.3 | 24.9 |

### Example 1a

Example 1 was repeated using a coating solution of 1,4-butanediol dissolved in water.

The results are shown in Table 1a below, and graphically in FIG. 1a.

TABLE 1a

| Diol wt. % | CRC (g/g) | AAP (g/g) |
|---|---|---|
| 0.4 | 26.7 | 24 |
| 0.6 | 25.6 | 24.5 |
| 0.8 | 25.7 | 24.1 |
| 1.0 | 25.7 | 24.7 |
| 1.2 | 25 | 23.7 |
| 1.4 | 25.9 | 24.2 |
| 1.6 | 25.2 | 25.3 |

### Comparative Example 1b

Example 1a was repeated by employing as solvent a solution consisting of 50/50 (by weight) water/methanol. The results are shown in Table 1b below and graphically in FIG. 1b. It will be seen from a comparison of Example 1a and this Comparative Example that satisfactory values for CRC and AAP can be obtained in the absence of methanol using water only as solvent without the need for a solvent such as methanol.

TABLE 1b

| Diol wt. % | CRC (g/g) | AAP (g/g) |
|---|---|---|
| 0.2 | 27.7 | 23.2 |
| 0.4 | 25.8 | 24.2 |
| 0.6 | 25.7 | 25.2 |
| 0.8 | 26.6 | 24.8 |

### Example 2

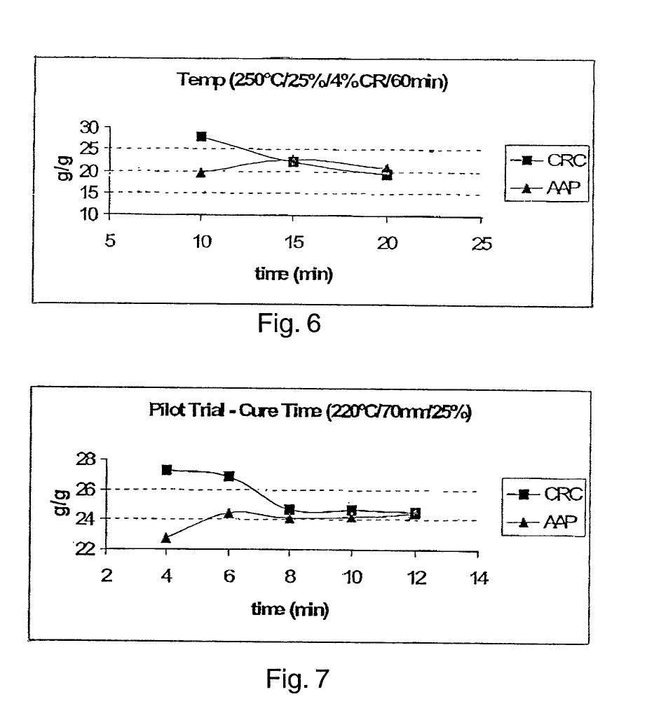

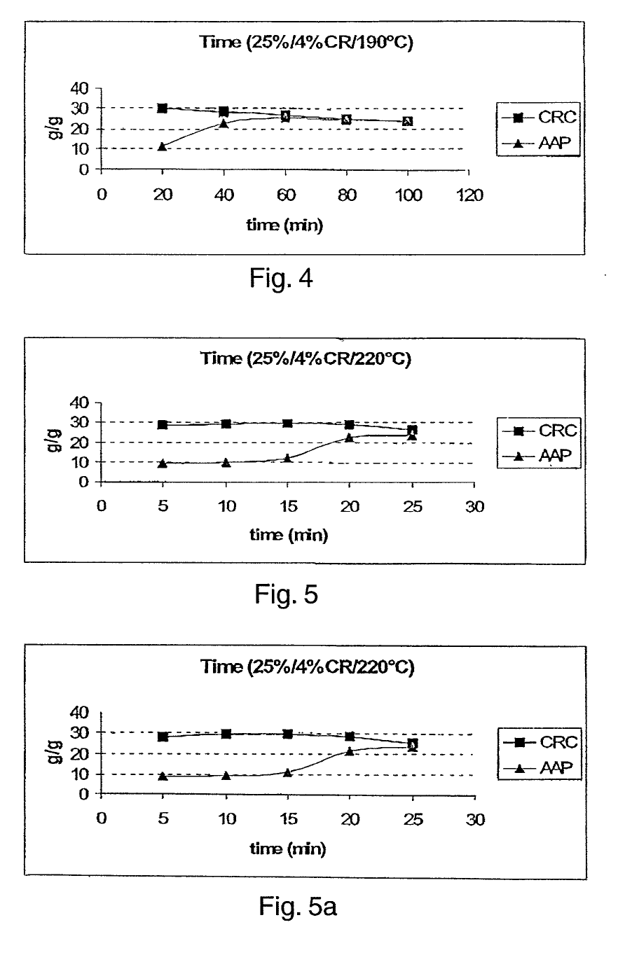

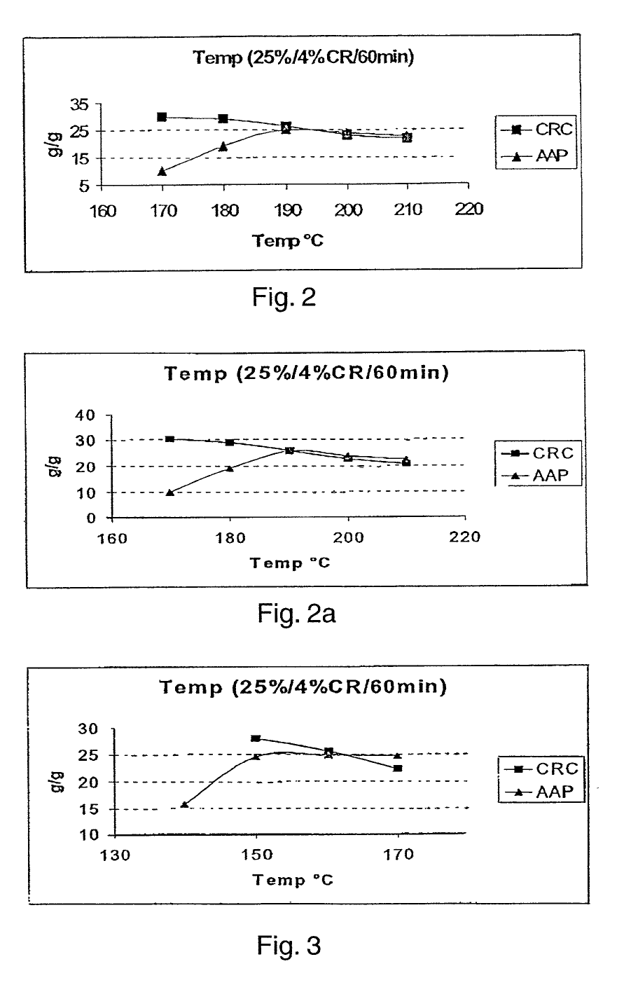

Example 1 was repeated using a concentration of 2-methyl-1,3-propanediol of 1.0 wt %, (based on weight of polymer powder), a cure time of 60 minutes and a coating ratio of 4%, but varying the temperature employed. The results are shown in Table 2 below and graphically in FIG. 2.

TABLE 2

| Temp ° C. | CRC (g/g) | AAP (g/g) |
|---|---|---|
| 170 | 30.0 | 10.1 |
| 180 | 29.1 | 19.2 |
| 190 | 26.2 | 24.9 |
| 200 | 23.0 | 23.7 |
| 210 | 21.7 | 22.6 |

### Example 2a

Example 2 was repeated using 1,4-butanediol. The results are shown in Table 2a below and graphically in FIG. 2a.

TABLE 2a

| Temp ° C. | CRC (g/g) | AAP (g/g) |
|---|---|---|
| 170 | 30.3 | 9.9 |
| 180 | 28.9 | 18.9 |
| 190 | 25.9 | 25.6 |
| 200 | 22.7 | 23.8 |
| 210 | 20.7 | 22.5 |

### Example 3

Example 2a was repeated using a cure time of 16 hours (overnight) but varying the cure temperature. The results are shown in Table 3 below and graphically in FIG. 3.

TABLE 3

| Temp ° C. | CRC (g/g) | AAP (g/g) |
|---|---|---|
| 140 | | 15.8 |
| 150 | 28 | 24.6 |
| 160 | 25.6 | 24.9 |
| 170 | 22.3 | 24.7 |

### Example 4

Example 1a was repeated using a concentration of diol of 1.0 wt. %, a cure temperature of 190° C. and a coating ratio of 4%. The cure time was varied for each sample. The results are shown in Table 4 below and graphically in FIG. 4.

TABLE 4

| Time | CRC (g/g) | AAP (g/g) |
|---|---|---|
| 20 | 30 | 11.1 |
| 40 | 28.2 | 22.9 |
| 60 | 26.9 | 25.7 |
| 80 | 25.1 | 24.3 |
| 100 | 24.1 | 23.8 |

### Example 5

Example 4 was repeated but using a cure temperature of 220° C., and using 2-methyl-1,3-propanediol. The results are shown in Table 5 below and graphically in FIG. 5.

TABLE 5

| Time (min) | CRC (g/g) | AAP (g/g) |
|---|---|---|
| 5 | 28.4 | 9.4 |
| 10 | 29.2 | 9.8 |
| 15 | 29.6 | 12.2 |
| 20 | 29.0 | 22.2 |
| 25 | 26.2 | 23.4 |

### Example 5a

Example 5 was repeated using 1,4-butanediol. The results are shown in Table 5a below and graphically in FIG. 5a.

TABLE 5a

| Time (min) | CRC (g/g) | AAP (g/g) |
|---|---|---|
| 5 | 28 | 8.9 |
| 10 | 29.5 | 9.5 |
| 15 | 29.7 | 11.2 |
| 20 | 28.5 | 21.6 |
| 25 | 25.4 | 23.7 |

### Example 6

Example 4 was repeated but using a cure temperature of 250° C. The results are shown in Table 6 below and graphically in FIG. 6.

TABLE 6

| Time (min) | CRC (g/g) | AAP (g/g) |
|---|---|---|
| 10 | 27.8 | 19.5 |
| 15 | 22.1 | 22.7 |
| 20 | 19.4 | 20.7 |

### Example 7

A pilot scale experiment was carried out using 10 kg of powdered base polymer The experiment was carried out at a temperature of 220° C. with a coating ratio of 4% and a diol concentration of 1%.

The results are shown in Table 7 below and graphically in FIG. 7.

TABLE 7

| Time (min) | CRC (g/g) | AAP (g/g) |
|---|---|---|
| 4 | 27.3 | 22.7 |
| 6 | 26.9 | 24.4 |
| 8 | 24.7 | 24.1 |
| 10 | 24.7 | 24.2 |
| 12 | 24.5 | 24.4 |

I claim:

1. A process for preparing a coated water-absorbing composition, which process comprises coating a super-absorbent polymeric material with an aqueous coating medium that besides water comprises at least one polyhydric alcohol having hydroxyl substituents on non-adjacent carbon atoms, and wherein the medium is substantially free of an organic solvent.

2. A process as claimed in claim 1, wherein the at least one polyhydric alcohol is selected from 2-methyl-1,3-propanediol, 1,4-butanediol, 1,3-propanediol and a low molecular weight polyethylene glycol.

3. A process as claimed in claim 1, wherein the polyhydric alcohol is 2-methyl-1,3-propanediol.

4. A process as claimed in claim 1, wherein the super-absorbent polymeric material is selected from one and mixtures of more than one of the following, namely:
a part-neutralised water-insoluble hydrogel-forming resin derived from cross-linked polyacrylic acid;
a partially neutralised acrylate polymer cross-linked with less than about 2% trimethylolpropane triacrylate; and
the hydrolzate of a starch-acrylonitrile graft polymer; the neutralisation product of a starch-acrylic acid graft polymer; the saponification product of a vinyl acetate-acrylic ester copolymer; the hydrolysate of an acrylonitrile copolymer; and hydrolysate of an acrylamide copolymer.

5. A process as claimed claim 1, wherein coating of the super-absorbent polymeric material with the coating medium is carried out at a temperature in the range of from about 140° C. to about 250° C. and for a period in the range of from about 5 minutes to about 2 hours.

6. A process as claimed in claim 1, wherein a coating of the super-absorbent polymeric material with the coating medium is carried out at a temperature in the range of from about 180° C. to about 220° C. and for a period in the range of from about 10 to about 40 minutes.

7. A process as claimed in claim 1, wherein the concentration of polyhydric alcohol in the coating medium is such that the ratio of the total weight of the polyhydric alcohol to the total weight of polymer is in the range of from about 0.002:1 to about 0.032:1.

8. A process as claimed in claim 1, wherein the concentration of polyhydric alcohol in the coating medium is such that the ratio of the total weight of polyhydric alcohol to the total weight of polymer is in the range of from about 0.004:1 to about 0.016:1.

9. A process as claimed in claim 1, wherein the ratio of the total weight of the coating medium to the total weight of the polymer, is in the range of from about 0.001:1 to about 1:1.

10. A process as claimed in claim 1, wherein the ratio of the total weight of the coating medium to the total weight of the polymer is in the range of from about 0.01:1 to about 0.1:1.

11. A process as claimed in claim 1, wherein the ratio of the total weight of the coating medium to the total weight of the polymer is in the range of from about 0.03:1 to about 0.06:1.

12. A personal hygiene product which comprises a coated water-absorbing composition prepared by coating a super-absorbent polymeric material with an aqueous coating medium that besides water comprises at least one polyhydric alcohol having hydroxyl substituents on non-adjacent carbon atoms, and wherein the medium is substantially free of an organic solvents.

13. A personal hygiene product according to claim 12, wherein the at least one polyhydric alcohol is selected from 2-methyl-1,3-propanediol, 1,4-butanediol, 1,3-propanediol and a low molecular weight polyethylene glycol.

14. A personal hygiene product according to claim 13, wherein the polyhydric alcohol is 2-methyl-1,3-propanediol.

15. A personal hygiene product according to claim 12, wherein the super-absorbent polymeric material is selected from one and mixtures of more than one of the following, namely:
a part-neutralised water-insoluble hydrogel-forming resin derived from cross-linked polyacrylic acid;
a partially neutralised acrylate polymer cross-linked with less than about 2% trimethylolpropane triacrylate; and
the hydrolyzate of a starch-acrylonitrile graft polymer; the neutralisation product of a starch-acrylic acid graft polymer; the saponification product of a vinyl acetate-acrylic ester copolymer; the hydrolysate of an acrylonitrile copolymer; and the hydrolysate of an acrylamide copolymer.

16. A personal hygiene product according to claim 12, wherein the concentration of polyhydric alcohol in the coating medium is such that the ratio of the total weight of the polyhydric alcohol to the total weight of the polymer is in the range of from about 0.002:1 to about 0.032:1.

17. A personal hygiene product according to claim 16, wherein the concentration of polyhydric alcohol in the coating medium is such that the ratio of the total weight of polyhydric alcohol to the total weight of the polymer is in the range of from about 0.004:1 to about 0.016:1.

18. A personal hygiene product according to claim 12, wherein the ratio of the total weight of the coating medium to the total weight of the polymer is in the range of from about 0.001 to about 1:1.

19. A personal hygiene product according to claim 18, wherein the ratio of the total weight of the coating medium to the total weight of the polymer is in the range of from about 0.01:1 to about 0.1:1.

20. A coated water-absorbing composition which comprises a super-absorbent polymeric material crosslinked with at least one polyhydric alcohol having hydroxyl substituents on non-adjacent carbon atoms.
